(19) United States
(12) Patent Application Publication
(10) Pub. No.: US 2010/0189084 A1
(43) Pub. Date: Jul. 29, 2010

(54) METHOD AND SYSTEM FOR OPTIMAL CONTROL OF DATA DELIVERY PATHS FOR A FEMTOCELL NETWORK

(76) Inventors: Xuemin (Sherman) Chen, San Diego, CA (US); Charles Abraham, Los Gatos, CA (US); Wael William Diab, San Francisco, CA (US); Vinko Erceg, Cardiff, CA (US); Victor Hou, LaJolla, CA (US); Jeyhan Karaoguz, Irvine, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 12/359,877

(22) Filed: Jan. 26, 2009

(51) Int. Cl. H04W 4/00

(52) U.S. Cl. 370/338

(57) ABSTRACT

A network controller within a femtocell may be operable to control communication of data among devices within a communication system comprising the femtocell and one or more other femtocells, end-point devices, base stations and/or access points and with devices external to the communication system. The network controller may receive and/or analyze status, measurements and/or operating constraints of one or more of the devices. Quality of service constraints, latency constraints, data type constraints and/or security constraints for communication of the data may be determined. The network controller may allocate physical and/or logical resources, may control security and/or quality of service and/or may allocate bandwidth for the communication of the data. The network controller may assign one or more of the devices comprised by the communication system to handle the communication of the data. The data may be communicated via wired, optical and/or wireless interfaces.

### CROSS-REFERENCE TO RELATED APPLICATIONS/INCORPORATION BY REFERENCE

Not applicable.

### FIELD OF THE INVENTION

Certain embodiments of the invention relate to communications. More specifically, certain embodiments of the invention relate to a method and system for optimal control of data delivery paths for a femtocell network.

### BACKGROUND OF THE INVENTION

Femtocells are wireless base stations that may be placed in a customer's residence or in a small business environment as well. Femtocells may be utilized for off-loading macro radio network traffic, improving coverage locally in a cost-effective manner, and/or implementing home-zone services to increase revenue. Femtocells, like macro cell base stations, may be enabled to connect “standard” phones to a cellular provider's network by a physical broadband connection which may be a digital subscriber line (DSL) connection and/or a cable connection, for example. Since the traffic between a customer's premises femtocell equipment and the operator's network may be traversing a public network, the traffic may be prone to various risks.

Communication between femtocells and one or more cellular provider's networks enables operation in private and public areas. The capacity of a femtocell may be adequate to address a typical family use model supporting two to four simultaneous voice calls and/or data traffic, for example.

An important characteristic of femtocells is their ability to control access. In an open access scenario, any terminal and/or subscriber may be allowed to communicate with the femtocell. Accordingly, the femtocell usage may somewhat resemble that of a macrocell system. In a closed access scenario, the femtocell may serve a limited number of terminals and/or subscribers that may be subscribed to a given cellular base station. In this regard, the cellular base station may be perceived as being deployed for private usage.

A regulatory issue with regard to femtocells is that they use licensed frequencies that radiate at a very low power in a controlled environment. It may be likely that they may not require a license from a local authority, as macrocell base stations do. An additional regulatory issue may arise from the relationship between a femtocell operator and a broadband services operator. One possible scenario may include the broadband operator being unaware of the existence of a femtocell operator. Conversely, the broadband operator and femtocell operator may have an agreement or they may be the same operator, for example. Interference between femtocells may be an issue for femtocell deployments based on wideband technologies such as WCDMA, for example, because initial operator deployments may use the same frequency for both the femtocell and the macrocell networks or due to the proximity of femtocell base stations in dense urban areas.

There are a plurality of design models for deployment and integration of femtocells, for example, an IP based Iu-b interface, a session initiation protocol (SIP) based approach using an Iu/A interface, use of unlicensed spectrum in a technique known as unlicensed mobile access (UMA) and/or use of IP multimedia subsystem (IMS) voice call continuity (VCC), for example.

In an Iu-b model based femtocell deployment approach, femtocells may be fully integrated into the wireless carrier's network and may be treated like any other remote node in a network. The Iu-b protocol may have a plurality of responsibilities, such as the management of common channels, common resources, and radio links along with configuration management, including cell configuration management, measurement handling and control, time division duplex (TDD) synchronization, and/or error reporting, for example. In Iu-b configurations, mobile devices may access the network and its services via the Node B link, and femtocells may be treated as traditional base stations.

In a SIP based femtocell deployment approach, a SIP client, embedded in the femtocell may be enabled to utilize SIP to communicate with the SIP-enabled mobile switching center (MSC). The MSC may perform the operational translation between the IP SIP network and the traditional mobile network, for example.

In a UMA based femtocell deployment approach, a generic access network (GAN) may offer an alternative way to access GSM and GPRS core network services over broadband. To support this approach, a UMA Network Controller (UNC) and protocols that guarantee secure transport of signaling and user traffic over IP may be utilized. The UNC may be enabled to interface into a core network via existing 3GPP interfaces, for example, to support core network integration of femtocell based services by delivering a standards based, scalable IP interface for mobile core networks.

In an IMS VCC based femtocell deployment approach, VCC may provide for a network design that may extend an IMS network to include cellular coverage and address the handoff process. The IMS VCC may be designed to provide seamless call continuity between cellular networks and any network that supports VoIP, for example. The VCC may also provide for interoperability between GSM, UMTS, and CDMA cellular networks and any IP capable wireless access network, for example. The IMS VCC may also support the use of a single phone number or SIP identity and may offer a broad collection of functional advantages, for example, support for multiple markets and market segments, provisioning of enhanced IMS multimedia services, including greater service personalization and control, seamless handoff between circuit-switched and IMS networks, and/or access to services from any IP device.

An access point is a device that may be placed in a customer's residence or in a business environment, for example, and may provide WLAN and/or WiFi service. An access point may be enabled to connect an endpoint device such as a computer or handheld wireless device to an intranet or an internet service provider (ISP) via a physical broadband connection which may be, for example, a digital subscriber line (DSL) connection and/or a cable connection. Access points may communicate in adherence to one or more 802.11 standards.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for optimal control of data delivery paths for a femtocell network, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary plurality of wireless endpoint devices communicating via a one or more network device based on control from a femtocell, in accordance with an embodiment of the invention.

FIG. 1B is a block diagram illustrating a plurality of exemplary network devices controlled by a femtocell, in accordance with an embodiment of the invention.

FIG. 1C is a block diagram illustrating an exemplary plurality of integrated network devices controlled by a femtocell, in accordance with an embodiment of the invention.

FIG. 1D is an exemplary block diagram of a femtocell comprising a network control processor, in accordance with an embodiment of the invention.

FIG. 1E is a block diagram of an exemplary access point, in accordance with an embodiment of the invention.

FIG. 1F is a block diagram of an exemplary endpoint device, in accordance with an embodiment of the invention.

FIG. 2 illustrates exemplary steps for managing data delivery to one or more endpoint devices by a femtocell comprising a network control processor, in accordance with an embodiment of the invention.

### DETAILED DESCRIPTION OF THE INVENTION

Certain embodiments of the invention may be found in a method and system for optimal control of data delivery paths for a femtocell network. In various embodiments of the invention, a communication system may comprise a femtocell, one or more other femtocells, one or more end-point devices, one or more base stations and/or one or more access points. The femtocell may comprise a network controller that may be operable to control communication of data between and/or among any two or more of the femtocell, the one or more other femtocells, the one or more end-point devices, the one or more base stations and/or the one or more access points. In addition, the network controller within the femtocell may control communication of the data between a communication device external to the communication system and one or more of the femtocell, the one or more other femtocells, the one or more end-point devices, the one or more base stations and/or the one or more access points. In this regard, the network controller within the femtocell may receive and/or analyze status, measurements and/or operating constraints of one or more of the femtocell, the one or more other femtocells, the one or more end-point devices, the one or more base stations and/or the one or more access points.

Furthermore, quality of service constraints, latency constraints, data type constraints and/or security constraints for the communication of the data may be determined. The network controller within the femtocell may allocate physical and/or logical resources, may control security and/or quality of service and/or may allocate bandwidth for the communication of the data. In various embodiments of the invention, the network controller in the femtocell may assign one or more of the femtocell, the one or more other femtocells, the one or more end-point devices, the one or more base stations and/or the one or more access points to handle the communication of the data. In this regard, the data may be communicated via one or more of wired, optical and/or wireless interfaces.

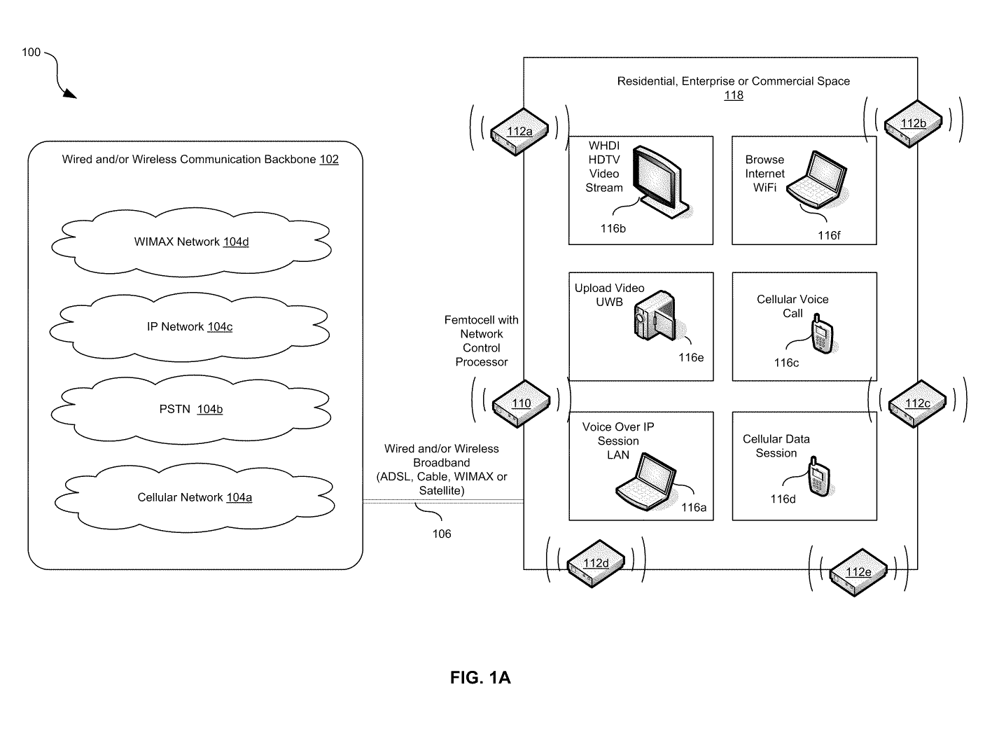

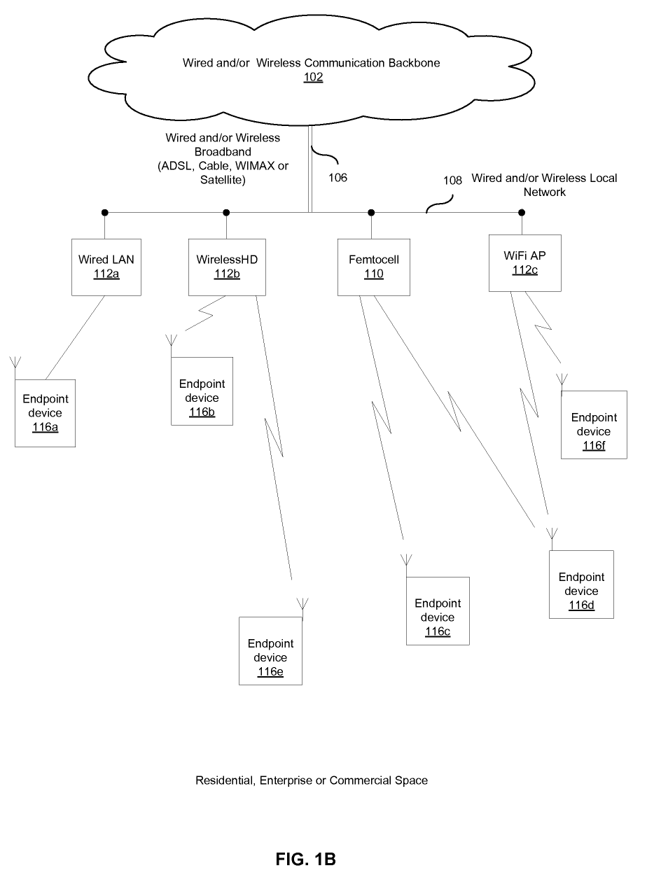

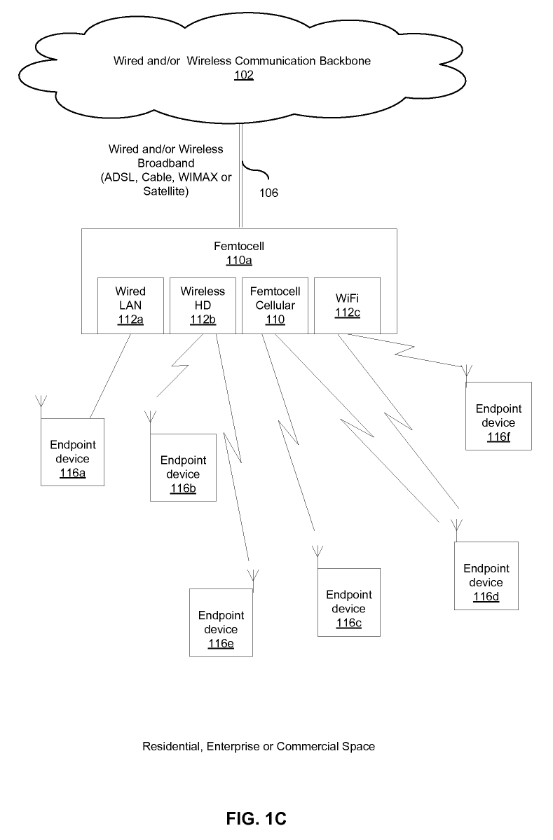

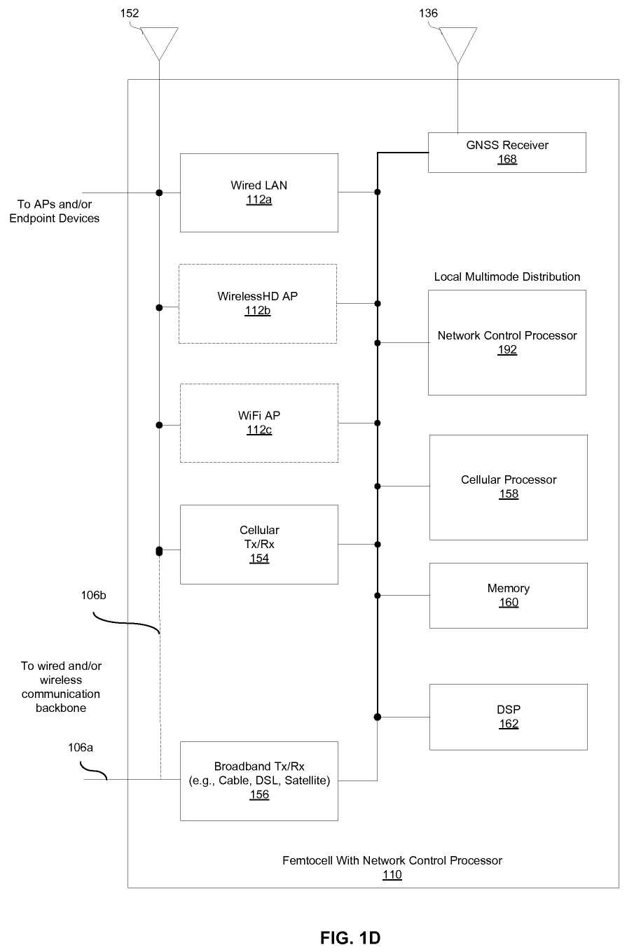

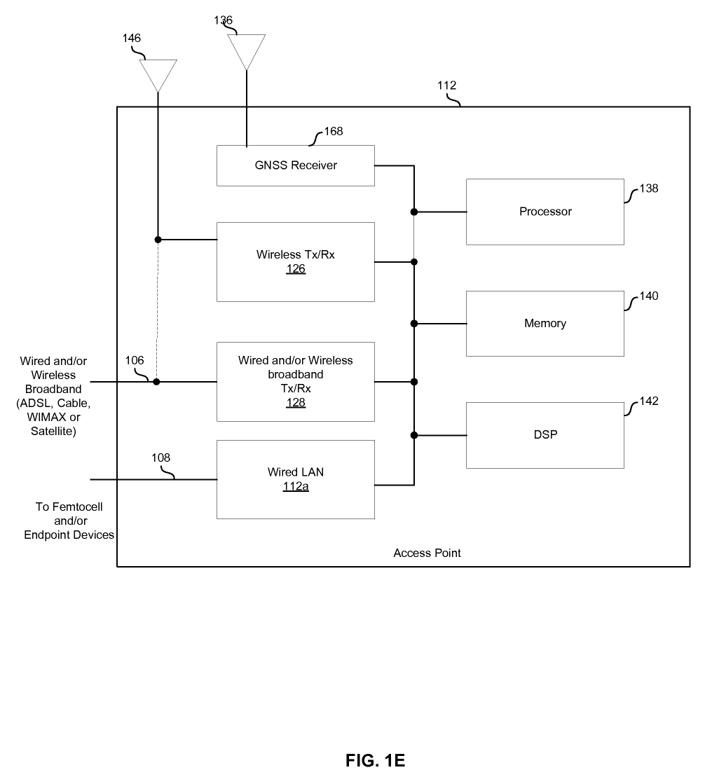

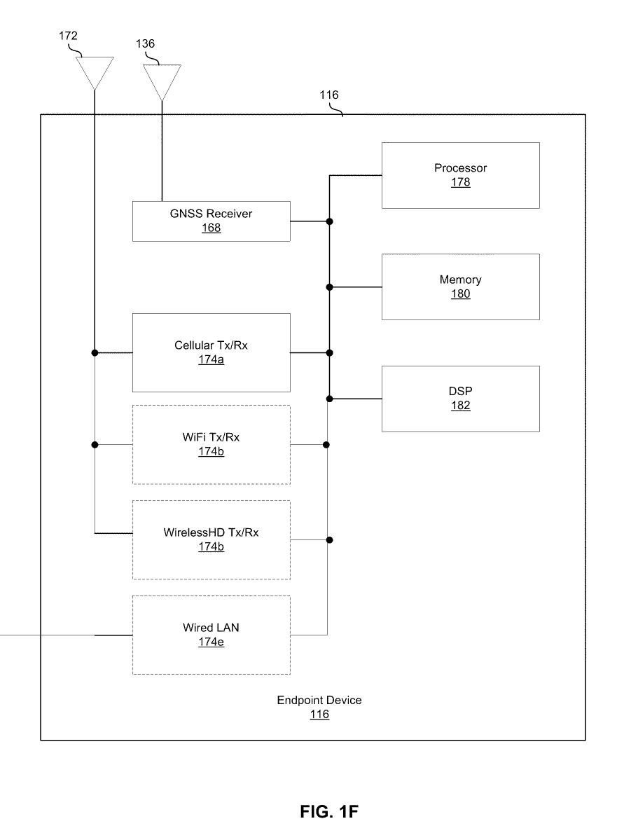

FIG. 1A is a diagram illustrating an exemplary plurality of wireless endpoint devices communicating via a one or more network device based on control from a femtocell, in accordance with an embodiment of the invention. Referring to FIG. 1A, there is shown a system of networks 100 comprising a wired and/or wireless communication backbone 102 which comprises a cellular network 104a, a public switched telephone network 104b, an IP network 104c and a WIMAX network 104d. In addition, a plurality of local communication devices 118 comprising a femtocell 110, another femtocell 112e, a wired LAN access point (AP) 112a, a WirelessHD access point (AP) 112b and a WiFi access point (112c), a cordless phone base station 112d. In addition, the FIG. 1A may comprise a plurality of diversified endpoint devices 116a . . . 116f that are collectively referred to herein as wireless endpoint devices 116. In addition, there is shown a broadband connection 106.

The plurality of local communication devices 118 may comprise, for example, the femtocell 110, another femtocell 112e, the wired LAN AP 112a, the WirelessHD AP 112b, the WiFi AP 112c, the base station 112d and the wireless endpoint devices 116. Although the plurality of local communication devices 118 are shown to comprise specific types of local communication devices, the invention is not so limited. In this regard, the plurality of local communication devices 118 may comprise any suitable base station, AP and/or endpoint device. The plurality of local communication devices 118 that may be located in or near an enterprise system, commercial properties, residential properties and/or multi-tenant properties for example. The enterprise system may be deployed in or near office buildings, schools, hospitals or government buildings for example. The commercial properties may comprise, for example, stores, restaurants and/or offices. The residential properties may comprise, for example, single-family homes, home offices, and/or town-houses. Multi-tenant properties may comprise residential and/or commercial tenants such as apartments, condos, hotels, and/or high rises. Furthermore, the plurality of local communication devices 118 may be located indoors and/or outdoors. In various embodiments of the invention, the femtocell 110 may be operable to manage voice and/or data traffic between the local endpoint devices 116 and the plurality of networks that are accessible via the wired and/or wireless communication backbone 102. Data traffic may comprise multimedia data comprising video, still images, animated images, and/or text. In addition, the femtocell 110 may be operable to manage local traffic between various endpoint devices 116 operating within the plurality of local communication devices 118.

The femtocell 110 may comprise suitable logic, circuitry and/or code that are operable to communicate based on one or more cellular wireless standards with one or more of the endpoint devices 116. In addition, the femtocell 110 may be operable to assign calls and/or sessions for the plurality of wireless endpoint devices 116 to the wired LAN AP 112a, the WirelessHD AP 112b, the femtocell 110 and/or the WiFi AP 112c. Although the other femtocell 112e, the base station 112d, the wired LAN AP 112a, the WirelessHD AP 112b, the WiFi AP 112c (collectively referred to herein as the APs 112) are shown in the FIG. 1A, the invention is not limited with regard to any specific type of local access point, femtocell or base station. For example, any APs, femtocells and/or base stations that may adhere to any suitable communication standard may be utilized. In addition, a plurality of one or more types of APs, femtocells and/or base stations may be utilized.

In various embodiments of the invention, the femtocell 110 may be operable to function as a gateway to handle data delivery between the femtocell 110 and/or APs 112 and the broadband connection 106. In other embodiments of the invention, the data may be delivered directly from the broadband connection 106 to the various APs 112 and/or femtocell 110. Furthermore, the femtocell 110 may be operable determine the best delivery path for data between the broadband connection 106 and the endpoint devices 116 with regard to quality of service (QoS), type of data, latency, performance metrics, power consumption and monetary cost of data delivery. In various embodiments of the invention, the femtocell 110 and/or the plurality of wireless endpoint devices 116 may be managed by a service provider, for example, a service provider of the cellular network 104a. The service provider of, for example the cellular network 104a, may license frequencies utilized by one or more of the femtocell 110 and/or the plurality of wireless endpoint devices 116.

In addition, the femtocell 110 may be operable to control one or more aspects of communication among the wireless endpoint devices 116. For example, resource allocation and mobility management such as for handoffs and/or simultaneous connections may be managed by the femtocell 110. In addition, the femtocell 110 may limit or control access and/or handoffs to other network access devices, for example, handoffs may be restricted to macrocell base stations, femtocells and/or access points serving in the local area. The femtocell 110 may be communicatively coupled to the wired and/or wireless communication backbone 102 via the broadband connection 106. For example, the femtocell 110 may send and/or receive data and/or voice to and/or from one or more of the cellular network 104a and/or other networks 104 via the broadband connection 106.

The wired and/or wireless communication backbone 102 may comprise suitable logic, circuitry and/or code that may be operable to provide access to a plurality of networks, for example, the cellular network 104a, the public switched telephone network (PSTN) 104b, the IP network 104c and/or the WIMAX network 104d. In addition, various networks and/or sub-networks, network devices and/or private intranets (not shown) may be accessed via the wired and/or wireless communication backbone 102. Although the networks 104 are shown in the FIG. 1A, the invention is not limited with regard to any specific type of network and may comprise any suitable communication network and/or access method. The wired and/or wireless communication backbone 102 may enable the plurality of local communication devices 118 to communicate with remote resources, for example, remote endpoint devices, application servers on the Internet, private network resources and other network devices. The wired and/or wireless backbone 102 may be communicatively coupled to the femtocell 110 and/or the APs 112 via the broadband connection 106. In this regard, the wired and/or wireless communication backbone 102 may comprise wireless base stations that enable access to the various networks 104. For example, the broadband connection 106 may comprise a WIMAX wireless link. In this regard, data may be delivered between the wired and/or wireless backbone 102 and the plurality of local communication devices 118 via a WIMAX base station (not shown) and the wireless network 104d.

In operation, the femtocell 110 may be operable to manage communication between the endpoint devices 116 and the networks 104 and/or other devices within the wired and/or wireless communication backbone 102. In addition, the femtocell 110 may be operable to manage communication among the local communication devices 118, for example, between the various endpoint devices 116 via the APs 112 and/or the femtocell 110. The femtocell 110 may be operable to determine a most appropriate AP 112 and/or femtocell 110 to handle a particular call or session. In this regard, the femtocell 110 may improve, for example, QoS, latency, power consumption, monetary cost and/or performance metrics. For example, the femtocell 110 may utilize one or more of QoS priority levels, inspection of data, load balancing, congestion avoidance and bandwidth allocation to determine which of the plurality of local communication devices 118 may best serve a call and/or session. In addition, the femtocell 110 may manage one or more of authentication and/or security operations, establishment of calls and/or communication sessions, communication session and/or call processing and mobility management for the plurality of local communication devices 118.

In various embodiments of the invention, configuration parameters may be communicated by the femtocell 110 to the APs 112 and/or endpoint devices 116, for example, data rate, modulation scheme, frequency allocation, code and/or time slot allocation, physical resource allocation, error coding schemes, and transmission power levels parameters. In addition, feedback information from the APs 112 and/or endpoint devices 116 may be sent to the femtocell 110, for example, round trip path delay, received signal strength, measured interference, bit error rates, available bandwidth. Furthermore, timing information and/or location of the endpoint devices 116 and/or of one or more of the APs 112 and/or femtocell 110 may be provided. In this regard, global navigation satellite system (GNSS) timing and/or location coordinates may be provided. Additionally, feedback from endpoint devices 116 may indicate the capabilities of that device to the femtocell 110. Exemplary capabilities which may be communicated may comprise wireless communication standards that may be supported by an endpoint device, a hardware configuration, a software configuration, maximum transmit power, and battery strength. In this manner, the femtocell 110 may be enabled to manage calls and/or sessions within the plurality of local communication devices 118. In various embodiments of the invention, the femtocell 110 may send and/or receive information to and/or from a service provider so that the service provider may also manage various aspects of communication by the plurality of local communication devices 118. For example, the service provider may assign frequencies and/or restrict transmission power levels of femtocells and/or endpoint devices within the plurality of local communication devices 118 in order to reduce interference to nearby macrocell base stations and/or other endpoint devices.

FIG. 1B is a block diagram illustrating a plurality of exemplary network devices controlled by a femtocell, in accordance with an embodiment of the invention. Referring to FIG. 1B, there is shown the wired and/or wireless communication backbone 102, the broadband connection 106, a wired and/or wireless local connection 108, the femtocell 110, the APs 112 and the endpoint devices 116.

The wired and/or wireless communication backbone 102, the broadband connection 106, the femtocell 110, the APs 112 and the endpoints 116 are similar and/or the same as the wired and/or wireless communication backbone 102, the broadband connection 106, the femtocell 110, the APs 112 and the endpoints 116 described with respect to FIG. 1A.

The broadband connection 106 comprises suitable logic circuitry and/or code that is operable to carry traffic for the femtocells 110 and the APs 112 to and/or from the wired and/or wireless communication backbone 102. For example, the broadband connection 106 may be operable to transport IP packets to one or more of the networks 104 described with respect to FIG. 1A. In addition, the broadband connection 106 may provide access to the Internet and/or one or more private networks. The broadband connection 106 may comprise one or more of optical, wired, and/or wireless links. In various embodiments of the invention, the broadband connection 106 may comprise one or more of a digital subscriber line (DSL), a passive optical network (PON), a T1/E1 line, a cable television infrastructure, a satellite television infrastructure and/or a satellite broadband Internet connection for example. In various embodiments of the invention, the broadband connection 106 may comprise, for example, a WIMAX base station (not shown) and the femtocell 110 may communicate with the networks 104 via the WIMAX base station and the WIMAX network 104d.

The wired and/or wireless local connections 108 may comprise suitable logic, circuitry and/or code that is operable to communicate data traffic and/or control signals between the femtocell 110, the APs 112 and/or the broadband connection 106. For example, the wired and/or wireless local connections 108 may handle Ethernet traffic in adherence to variations and/or extensions of 802.3 communication standards and/or WLAN traffic in adherence to variations and/or extensions of 802.11 communication standards. In this regard, the femtocell 110 may communicate with the APs 112 via the wired and/or wireless local connection 108 in order to manage traffic within the plurality of local communication devices 118. In various embodiments of the invention, the wired and/or wireless local connection 108 may comprise copper and/or fiber links and/or one or more hubs, switches and/or routers (not shown).

The femtocell 110 may comprise suitable logic, circuitry, and/or code that may be operable to communicate wirelessly with the endpoint devices 116 utilizing one or more cellular standards such as IS-95, CDMA, LTE, GSM, TDMA, GPRS, EDGE, UMTS/WCDMA, TD-SCDMA, HSDPA, extensions thereto, and/or variants thereof. Data may comprise any analog and/or digital information including but not limited to voice, Internet data, and/or multimedia content. Multimedia content may comprise audio and/or visual content comprising, video, still images, animated images, and/or textual content. The femtocell 110 may communicate with various devices such as the endpoint devices 116. Exemplary cellular standards supported by the femtocells 110 may be specified in the International Mobile Telecommunications-2000 (IMT-2000) standard and/or developed by the 3rd generation partnership project (3GPP) and/or the 3rd generation partnership project 2 (3GPP2). Additionally, the femtocell 110 may comprise suitable logic, circuitry, and/or code that may be operable to communicate utilizing IP protocol over a broadband connection 106 with one or more networks, endpoint devices and/or network devices within the networks 104 and/or the wired and/or wireless communication backbone 102. In various embodiments of the invention, the femtocell 110 may comprise suitable logic, circuitry and/or code that may be operable to control communication by the plurality of local communication devices 118.

The APs 112 comprise suitable logic, circuitry and/or code that may be operable to provide connectivity to one or more of the endpoint devices 116 via, for example, WiFi, WirelessHD and/or Ethernet interfaces. In this regard, the APs 112 may provide Internet connectivity, multimedia data transfer, high definition multimedia streaming, web browsing and/or IP telephony sessions for the endpoint devices 116 for example. Communication to and/or from the APs 112 may be managed by the femtocell 110 via the wired and/or wireless connection 108. For example, the APs 112 may communicate with the femtocell 110 based on one or more variations of and/or extensions to the 802.3 and/or 802.11 communication standards. In various embodiments of the invention, a plurality of APs 112 may be operable to support simultaneous sessions and/or handoffs for an endpoint device 116. In addition, one or more APs 112 and the femtocell 110 may be operable to support simultaneous sessions and/or handoffs for an endpoint device 116. In various embodiments of the invention, the APs 112 and/or femtocell 110 may be operable to support handoffs and/or simultaneous sessions with a macrocell, a base station or another device (not shown) that may be outside of the plurality of local communication devices 118 for an endpoint device 116.

The endpoint devices 116 may each comprise suitable logic, circuitry, and/or code that may be operable to communicate utilizing one or more wired and/or wireless standards. For example, the endpoint devices 116 may be operable to communicate with the APs 112 based on communication standards such as 802.3, 802.11, WirelessHD and variants thereof. In addition, the endpoint devices 116 may be operable to communicate with the femtocell 110 based on one or more wireless standards such as IS-95, CDMA, EVDO, GSM, TDMA, GPRS, EDGE, UMTS/WCDMA, TD-SCDMA, HSDPA, WIMAX and/or LTE. In addition, the endpoint devices 116 may be operable to communicate based on Bluetooth, Zigbee and/or other wireless technologies. The endpoint devices 116 may each be operable to communicate with the femtocell 110 and/or APs 112 as well as with other cellular base stations and/or APs outside of the plurality of communication devices 118. Exemplary endpoint devices 116 may comprise laptop computers, mobile phones, wired phones, media players, televisions and/or high definition televisions, set-top-boxes, video and/or still cameras, game consoles and/or location determination enabled devices. The endpoint devices 116 may be enabled to receive, process, and present multimedia content and may additionally be enabled run a web browser or other applications for providing Internet services to a user of an endpoint devices 116. In various embodiments of the invention, the endpoint devices 116 devices may be multimode devices that may be operable to communicate simultaneously via a plurality of interfaces with a plurality of femtocells and/or APs. For example, one or more endpoint devices 116 may be enabled to communicate with the femtocell 110 and with the AP 112a or with a Bluetooth device for example. In addition, the endpoint devices 116 may be enabled to communicate simultaneously with a plurality of femtocells 110 and/or a plurality of APs 112. Moreover, the endpoint devices 116 may be operable to perform handoffs, for example, between multiple femtocells, between femtocells and APs and/or between multiple APs.

In operation, the femtocell 110 may be operable to manage communication that is handled by the femtocell 110 and/or the APs 112. For example, the femtocell 110 may manage communication between the endpoint devices 116 and the femtocell 110 and/or APs 112. In addition, the femtocell 110 may manage communication of data between the plurality of communication devices 118 and remote endpoints via the wired and/or wireless backbone 102. In various embodiments of the invention, the femtocell 110 may act as a gateway and may send and/or receive content communicated by the femtocell 110 and/or the APs to and/or from the wired and/or wireless communication backbone 102 via the broadband connection 106. In other embodiments of the invention, content communicated by the APs 112 and/or the femtocell 110 may be delivered to and/or from the broadband connection 106 directly or via another gateway (not shown) for example. In various embodiments of the invention, the femtocell 110 may allocate bandwidth on the broadband connection 106 for the femtocell 110 and/or APs 112. In this regard, the femtocell 110 may determine which femtocell 110 and/or AP 112 may handle a call and/or session with the endpoint devices 116. In addition, the femtocell 110 may handle quality of service (QoS), security, latency and/or bandwidth allocation for femtocell 110 and/or AP 112 traffic that is transported via the broadband connection 106.

In various embodiments of the invention, the endpoint devices 116 may communicate with remote end point devices and/or application servers via the femtocell 110 and/or APs 112, the wired and/or wireless local connections 108, the broadband connection 106, the wired and/or wireless communication backbone 102 and one or more networks 104. For example, an endpoint device 116c may receive a phone call from a remote landline telephone (not shown) in the PSTN network 104b. In this regard, the femtocell 110 may self assign the phone call. The femtocell 110 and the endpoint device 116c may exchange data and/or voice utilizing one or more cellular standards. The femtocell 110 may packetize voice and/or data received from the endpoint device 116c for the remote endpoint device into one or more IP packets and the IP packets may be further encapsulated, encoded, modulated, or otherwise processed. The femtocell 110 may analyze available bandwidth, QoS levels and/or data type for managing traffic on the broadband connection 106 from itself and/or from the various APs 112. The IP packets may then be routed via the wired and/or wireless connections 108 and/or the broadband connection 106 to the remote endpoint device in the PSTN network 104b.

In another exemplary embodiment of the invention, the endpoint device 116b may initiate a connection with an application server (not shown) in the IP network 104c to download high definition (HD) multimedia data via the wired and/or wireless communication backbone 102. The femtocell 110 may determine that the AP 112b may be the most appropriate AP available to handle the HD multimedia downloading. For example, the endpoint device 116b may be an HD television which may be operable to communicate with the AP 112b in adherence to a WirelessHD standard at for example, 60 GHz. The AP 112b may send and/or receive data to and/or from the femtocell 110 via the wired and/or wireless connection 108. The femtocell 110 may receive and/or send data to and/or from the remote application server via the broadband connection 106 and the wired and/or wireless communication backbone 102. In various embodiments of the invention, the femtocell 110 may be operable to route HD multimedia data via the wired and/or wireless connections 108 between a plurality of endpoint devices 116.

FIG. 1C is a block diagram illustrating an exemplary plurality of integrated network devices controlled by a femtocell, in accordance with an embodiment of the invention. Referring to FIG. 1C, there is shown the wired and/or wireless communication backbone 102, the broadband connection 106, the femtocell 110 comprising integrated APs 112 and the endpoint devices 116.

The wired and/or wireless communication backbone 102, the broadband connection 106, the APs 112 and the endpoint devices 116 are described with respect to FIG. 1B and FIG. 1A. The femtocell 110a is similar to the femtocell 110 described with respect to FIG. 1A and FIG. 1B, however, the femtocell 110a comprises the femtocell 110 and the APs 112 within one physical unit.

The femtocell 110a comprises suitable logic, circuitry and/or code to perform the same functions as the femtocell 110 and the APs 112 however, the femtocell 110a is operable to communicate internally with the APs 112. In this regard, the femtocell 110a may be operable to manage communication between the femtocell 110a and/or the APs 112 and the endpoint devices 116. In addition, the femtocell 110 may manage data delivery via the broadband connection 106 to and/or from the femtocell 110a and/or the APs 112.

In operation, the endpoint device 116f may request a web browsing session on the Internet. The femtocell 110a may determine that the AP 112c may be the most appropriate AP available to handle the web browsing session for the endpoint device 116f. For example, the endpoint device 116f may be a laptop, which may be operable to communicate with the AP 112c in adherence with an 802.11 wireless standard for example. The AP 112c may send and/or receive web browsing data to and/or from the femtocell 110a via the wired and/or wireless connection 108. The femtocell 110a may receive and/or send data to and/or from the Internet via the broadband connection 106 and the wired and/or wireless communication backbone 102. In addition, the femtocell 110a may analyze QoS, latency, data type, bandwidth availability and/or performance measurements for a plurality of varied broadband streams and/or voice calls communicated over the broadband connection 106. In this regard, the femtocell 110a may coordinate resources in order to optimize service quality, power consumption, cost and/or performance metrics.

FIG. 1D is an exemplary block diagram of a femtocell comprising a network control processor, in accordance with an embodiment of the invention. Referring to FIG. 1D, there is shown a femtocell 110 comprising an antenna 152, a cellular transmitter and/or receiver (Tx/Rx) 154, a wired and/or a wireless broadband transmitter and/or receiver (Tx/Rx) 156, a cellular processor 158, a memory 160, a digital signal processor (DSP) 162, a global navigation satellite system (GNSS) receiver 168 and a GNSS antenna 136. In addition, the femtocell 110 may comprise a network control processor 192, a wired LAN interface 112a, an optional wireless HD interface 112d, an optional WiFi interface 112c, the broadband connection 106 and/or the wired and/or wireless local connection 108.

The femtocell 110 may be similar to or the same as the femtocell 110 described with respect to FIG. 1A, FIG. 1B. In addition, the femtocell 110 shown in FIG. 1D may be similar to and/or the same as the femtocell 110a described with respect to FIG. 1C. In addition, the wired LAN interface 112a, the optional wireless HD interface 112d, the optional WiFi interface 112c, the broadband connection 106 and/or the wired and/or wireless local connection 108 are described with respect to FIG. 1A, FIG. 1B and FIG. 1C. The wired LAN interface 112a, the optional wireless HD interface 112d, the optional WiFi interface 112c are shown internal to the femtocell 110a in FIG. 1C.

The GNSS receiver 168 and GNSS antenna 136 comprise suitable logic, circuitry and/or code to receive signals from one or more GNSS satellites, for example, GPS satellites. The received signals may comprise timing, ephemeris and/or almanac information that enable the GNSS receiver 168 to determine its location and/or time.

The antenna 152 may comprise suitable circuitry that is operable to transmit and/or receive cellular signals, Wireless HD and/or various 802.11 signals for example. Although a single antenna is illustrated, the invention is not so limited. In this regard, various transmitters and/or receivers within the femtocell 110, for example the cellular Tx/Rx 154, the wired and/or wireless broadband Tx/Rx 156, the optional WiFi interface 112c and/or the optional WirelessHD interface 112b may utilize a common antenna for transmission and reception, may utilize different antennas for transmission and reception, and/or may utilize a plurality of antennas for transmission and/or reception. In addition, various smart and/or adaptive antenna systems such as MIMO antennas may be utilized which may be capable of beam forming for example.

The cellular Tx/Rx 154 may comprise suitable logic circuitry and/or code that may be operable to transmit and/or receive voice and/or data utilizing one or more cellular standards. The cellular Tx/Rx 154 may be operable to perform amplification, down-conversion, filtering, demodulation, and analog to digital conversion of received cellular signals. The cellular Tx/Rx 154 may be operable to perform amplification, up-conversion, filtering, modulation, and digital to analog conversion of transmitted cellular signals. The cellular Tx/Rx 154 may support communication over a plurality of communication channels utilizing time division multiple access (TDMA), code division multiple access (CDMA) and/or orthogonal frequency division multiplexing (OFDM) for example. In addition, the femtocell 110 may be operable to support exemplary cellular standards comprising International Mobile Telecommunications-2000 (IMT-2000) standards and/or standards developed by the 3^{rd} generation partnership project (3GPP) and/or the 3^{rd} generation partnership project 2 (3GPP2). In addition, the femtocell 110 may be enabled to support 4^{th} generation standards such as LTE. In various embodiments of the invention, the cellular Tx/Rx 154 may be enabled to measure received signal strength. Additionally, the cellular Tx/Rx 154 may be enabled to adjust a power level and/or a modulation scheme or level of transmitted signals.

The wired and/or wireless broadband Tx/Rx 156 may comprise suitable logic, circuitry, and/or code that may be operable to transmit and/or receive data in adherence to one or more wired and/or wireless communication standards. For example, the broadband Tx/Rx 156 may communicate based on Ethernet and/or WIMAX standards. In addition, the Tx/Rx 156 may be operable to interface with, for example, DSL and/or ADSL, PON, T1/E1, cable television infrastructure, satellite television infrastructure and/or satellite broadband Internet for example. In various embodiments of the invention, Tx/Rx 156 may be operable to communicate via the antenna 152 with a WIMAX base station (not shown) for example. In this regard, the Tx/Rx 156 may transmit and/or receive data via the broadband connection 106 with one or more remote networks and/or network devices. The broadband Tx/Rx 156 may be operable to perform amplification, down-conversion, filtering, demodulation, and analog to digital conversion of received signals. The broadband Tx/Rx 156 may be operable to perform amplification, up-conversion, filtering, modulation, and digital to analog conversion of transmitted signals.

The wired LAN interface 112a may comprise suitable logic, circuitry and/or code to enable the femtocell 110 to communicate with one or more of the APs 112 and/or one or more endpoint devices 116 based on the 802.3 communication standard and/or variations thereof. The wired LAN interface 112a may enable the femtocell 110 to communicate with the APs 112 via the wired and/or wireless connection 108.

The cellular processor 158 may comprise suitable logic, circuitry, and/or code that may enable processing data and/or controlling cellular communications operations of the femtocell 110. In this regard, the processor 158 may be enabled to provide control signals to the various other blocks within the femtocell 110. The processor 158 may also control data transfers between various portions of the femtocell 110. Additionally, the processor 158 may enable execution of applications programs and/or code. In various embodiments of the invention, the applications, programs, and/or code may enable, for example, parsing, transcoding, or otherwise processing data. In various embodiments of the invention, the applications, programs, and/or code may enable, for example, configuring or controlling operation of the cellular transmitter and/or receiver 154, the broadband transmitter and/or receiver 156, the DSP 162, and/or the memory 160. In various embodiments of the invention, the processor 158 may receive control information for the femtocell 110. In this regard, the processor 158 may be enabled to provide one or more signals to the cellular Tx/Rx 154, the memory 160, and/or the DSP 162 to control communication between the femtocell 110 and the endpoint devices 116. In addition, the processor 158 may control parameters such as power level, modulation scheme, error coding scheme, beam-forming and/or data rates of transmitted cellular signals.

The memory 160 may comprise suitable logic, circuitry, and/or code that may enable storage or programming of information that includes parameters and/or code that may effectuate the operation of the femtocell 110. A portion of the programming information and/or parameters may be received from the femtocell 110. Parameters may comprise configuration data and the code may comprise operational code such as software and/or firmware, but the information need not be limited in this regard. Moreover, the parameters may include for example, adaptive filter and/or block coefficients. Additionally, the memory 160 may buffer or otherwise store received data and/or data to be transmitted. In various embodiments of the invention, the memory 160 may comprise one or more look-up tables which may be utilized for determining cellular devices within a coverage area of the femtocell 110. In various embodiments of the invention, the memory 160 may comprise QoS and/or control parameters for traffic managed by the femtocell 110.

The DSP 162 may comprise suitable logic, circuitry, and/or code that may be operable to perform computationally intensive processing of data. In various embodiments of the invention, the DSP 162 may encode, decode, modulate, demodulate, encrypt, decrypt, scramble, descramble, and/or otherwise process data. In various embodiments of the invention, the DSP 162 may be enabled to adjust a modulation scheme, error coding scheme, and/or data rates of transmitted cellular signals data.

The network control processor 192 may comprise suitable logic, circuitry, and/or code that may enable the femtocell 110 to provide control signals to one or more of APs, to other femtocells (not shown) and/or to endpoint devices 116 in order to manage delivery of data among the endpoint devices 116 and/or between the endpoint devices 116 and the wired and/or wireless communication backbone 102 via the broadband connection 106. The network control processor 192 may comprise one or more general purpose processors and/or may comprise one or more special purpose processors or firmware, for example, a network controller. In this regard, the network control processor 192 may determine which communication resources may be utilized for communication by the plurality of local communication devices 118. For example, the processor 192 may be enabled to receive information from the APs 112, the femtocell 110, the endpoint devices 116 and/or a cellular service provider to determine which interface may be utilized for a particular data and/or voice connection with one or more of the endpoint devices 116.

The network control processor 192 may receive and/or analyze device capabilities, bandwidth availability and/or various signal performance and/or timing measurements of the plurality of local network devices 118. In this regard, the network control processor 192 may coordinate resources in order to optimize service quality, security, power consumption, monetary cost and/or performance metrics. In addition, the network control processor 192 may consider various attributes of data and/or voice to be delivered. For example, QoS, latency constraints, data type and/or security constraints such as digital rights management may be factors that may be utilized to determine which interface and/or device may handle a call and/or session for an endpoint device 116. In various embodiments of the invention, the network control processor 192 may comprise suitable logic, circuitry and/or code to perform deep packet inspection of data. For example, the femtocell 110 may receive a data stream via UDP for example. The network control processor 192 may be operable to parse and/or examine UDP and/or IP headers in the data stream and inspect RTP headers. The RTP header may indicate a type of data being transmitted or a payload format of the data. In this regard, the RTP header may indicate that the data stream comprises MPEG video or VOIP data for example.

In various embodiments of the invention, the network control processor 192 may comprise suitable logic, circuitry and/or code to enforce secure delivery of data by the APs 112 and/or the femtocell 110. In this regard, the network control processor 192 may consider the types of security operations supported by the various APs 112 and/or the femtocell 110 when determining which device may handle delivery of a particular packet and/or stream of data. For example, the network controller may determine that digital transmission content protection (DTCP) encryption may be applied to particular data received from a network 104 for delivery to an endpoint device 116. The network controller 192 may determine which AP 112 and/or femtocell 110 may handle the data based on their ability to support DTCP protection of the data.

In various embodiments of the invention, the processor 192 may communicate various control information to the APs 112, femtocell 110 and/or endpoint devices for example, data rate, modulation scheme, spectrum, code and/or time slot allocation, physical resource allocation, error coding schemes, and transmission power levels parameters. In addition, the network control processor 192 may be operable to handle bandwidth allocation, QoS and/or congestion avoidance for data delivered via the broadband connection 106 to and/or from the plurality of local communication devices 118.

In operation, the femtocell 110 may function as a cellular base station and may also provide control for a plurality of local communication devices 118. The femtocell may receive requests for establishing a call and/or session between an endpoint device 116 and a remote device or to another endpoint device within the plurality of local communication devices 118. The femtocell 110 may receive control information from a cellular service provider that operates the femtocell 110 and/or may receive measurements and/or status information from the APs 112 and/or femtocell 110. The femtocell 110 may determine which AP 112 and/or femtocell 110 may handle the call and/or communication session. In this regard, the femtocell 110 may allocate bandwidth on the broadband connection 106 for the call and/or session and may handle quality of service (QoS). The femtocell 110 may communicate control information to the selected femtocells 110 and/or AP 112 handling the call and/or session and may receive additional measurements and/or status from them. Furthermore, the femtocell 110 may control one or more of load balancing between APs 112 and femtocells 110, protection of content, call and/or session setup, call and/or session processing, resource allocation and mobility management for the femtocells 110 and/or APs 112. For example, the femtocell 110 may be operable to restrict handoffs for the call and/or session to the femtocell 110 and/or APs 112 within the plurality of local communication devices 118 and may limit access to and/or handoffs to other sub networks and/or macrocells (not shown).

FIG. 1E is a block diagram of an exemplary access point, in accordance with an embodiment of the invention. Referring to FIG. 1E, there is shown an AP 112 comprising an antenna 146, a wireless transmitter and/or receiver (Tx/Rx) 126, a wired and/or a wireless broadband transmitter and/or receiver (Tx/Rx) 128, a processor, a wired LAN Tx/Rx 112a, a process or 138, a memory 140, a digital signal processor (DSP) 142, a global navigation satellite system (GNSS) receiver 168 and a GNSS antenna 136. The AP 112 may be similar to or substantially the same as one or more of the APs 112, which are described with respect to, for example FIG. 1A, FIG. 1B and/or FIG. 1C.

The GNSS receiver 168 and GNSS antenna 136 may be similar and/or the same as the GNSS receive 168 and GNSS antenna 136 described with respect to FIG. 1D. The wired LAN interface 112a is described with respect to FIG. 1D.

The antenna 152 may be suitable for transmitting and/or receiving signals to and/or from the endpoint devices 116 and/or to and/or from the femtocell 110. Although a single antenna is illustrated, the invention is not so limited. In this regard, the WiFi Tx/Rx 126 and/or wired and/or wireless broadband Tx/Rx 128 may utilize a common antenna for transmission and reception, may utilize different antennas for transmission and reception, and/or may utilize a plurality of antennas for transmission and/or reception.

The wireless Tx/Rx 126 may comprise suitable logic circuitry and/or code that may be operable to transmit and/or receive data to the endpoint devices 116 utilizing one or more of 802.11 and/or Wireless HD standards for example. Although WiFi and WirelessHD are described with respect to the AP 112 wireless Tx/Rx 126, any Tx/Rx that may support a suitable wireless standard such as UWB, Bluetooth and/or Zigbee may be utilized. The wireless Tx/Rx 126 may be operable to perform amplification, down-conversion, filtering, demodulation, and analog to digital conversion of received WiFi signals. The WiFi Tx/Rx 126 may be operable to perform amplification, up-conversion, filtering, modulation, and digital to analog conversion of transmitted WiFi signals. The WiFi Tx/Rx 126 may support communication over a plurality of wireless communication channels to a plurality of endpoint devices 116. In various embodiments of the invention, the WiFi Tx/Rx 126 may be enabled to measure received signal strength and/or adjust a power level and/or a modulation scheme of transmitted signals. In various embodiments of the invention, an AP 112 may utilize the same Tx/Rx 126 for communicating with endpoint devices 116.

The wired and/or wireless broadband Tx/Rx 128 may comprise suitable logic, circuitry, and/or code that may be operable to transmit data via the broadband connection 106 to one or more entities in the wired and/or wireless communication backbone 102. In this regard, the wired and/or wireless broadband Tx/Rx 128 may communicate data for calls and/or sessions that are terminated at the one or more endpoint devices 116. The wired and/or wireless broadband Tx/Rx 128 may be operable to perform amplification, down-conversion, filtering, demodulation, and analog to digital conversion of received signals. The wired and/or wireless broadband Tx/Rx 128 may be operable to perform amplification, up-conversion, filtering, modulation, and digital to analog conversion of transmitted signals. In various exemplary embodiments of the invention, the wired and/or wireless broadband Tx/Rx 128 may transmit and/or receive data via the connection 106b and/or via the antenna 152. In various embodiments of the invention, an AP 112 may utilize the same Tx/Rx 128 for communicating data with the femtocell 110.

The processor 138 may comprise suitable logic, circuitry, and/or code that may enable processing of data and/or controlling operations of the AP 112. In this regard, the processor 138 may be enabled to provide control signals to the various other blocks comprising the AP 112. The processor 138 may also control data transfers between various portions of the AP 112. Additionally, the processor 138 may enable execution of applications programs and/or code. In various embodiments of the invention, the applications, programs, and/or code may enable, for example, parsing, transcoding, or otherwise processing data. In various embodiments of the invention, the applications, programs, and/or code may enable, for example, configuring or controlling operation of the wireless Tx/Rx 126, the broadband Tx/Rx 128, the DSP 142, and/or the memory 140. In various embodiments of the invention, the processor 138 may receive control information from the femtocell 110. In this regard, the processor 138 may be enabled to provide one or more signals to the wireless Tx/Rx 126, the wired and/or wireless broadband Tx/Rx 128, the LAN interface 112a, the memory 140, and/or the DSP 142 to control communication between the AP 112 and the endpoint devices 116. In addition, the processor 138 may control parameters such as power level, modulation scheme, error coding scheme, and/or data rates of transmitted WiFi signals.

The memory 140 may comprise suitable logic, circuitry, and/or code that may enable storage or programming of information that includes parameters and/or code that may effectuate the operation of the AP 112. A portion of the programming information and/or parameters may be received from the femtocell 110. Parameters may comprise configuration data and the code may comprise operational code such as software and/or firmware, but the information need not be limited in this regard. Moreover, the parameters may include adaptive filter and/or block coefficients. Additionally, the memory 140 may buffer or otherwise store received data and/or data to be transmitted. In various embodiments of the invention, the memory 140 may comprise one or more look-up tables which may be utilized for determining wireless access within a coverage area of the AP 112.

The DSP 142 may comprise suitable logic, circuitry, and/or code operable to perform computationally intensive processing of data. In various embodiments of the invention, the DSP 142 may encode, decode, modulate, demodulate, encrypt, decrypt, scramble, descramble, and/or otherwise process data. In various embodiments of the invention, the DSP 142 may be enabled to adjust a modulation scheme, error coding scheme, and/or data rates of transmitted wireless signal data.

In operation, the AP 112 may handle communication between one or more endpoint devices 116 and a remote communication device (not shown) in the wired and/or wireless communication backbone 102. In this regard, the broadband Tx/Rx 128 may receive network management messages from the femtocell 110. The processor 138 may utilize the received management messages to configure the wireless Tx/Rx 126 and/or the DSP 142 to control parameters of a wireless communication channel to the endpoint devices 116 such as transmission power levels, error coding scheme for transmitted cellular signals, data rates for transmitted cellular signals, and modulation scheme for transmitted signals. Additionally, management messages from the femtocell 110 may be relayed to the endpoint devices 116 via the wireless Tx/Rx 126.

The wireless Tx/Rx 126 may determine characteristics such as interference levels and signal strength of desired signals received via a WiFi communication channel. Similarly, the DSP 142 and/or the processor 138 may determine bit error rates of data received via a wireless communication channel and available bandwidth of the channel. The measurements may be communicated to the femtocell 110 by the wired LAN interface 112a and/or the Tx/Rx 128 via the wired and/or wireless connection 108. Additionally, the AP 112 may receive feedback from an endpoint device 116 via the wireless link that may also be communicated to the femtocell 110 via the wired and/or wireless connection 108.

FIG. 1F is a block diagram of an exemplary endpoint device, in accordance with an embodiment of the invention. The endpoint devices 116 may comprise a cellular Tx/Rx 174a, a WiFi Tx/Rx 176b, a WirelessHD Tx/Rx 174c, a wired LAN Tx/Rx 174c, an antenna 172, a global navigation satellite system (GNSS) receiver 168, a GNSS antenna 136, a processor 178, a memory 180, and a DSP 182. The endpoint devices 116 may be similar or the same as one or more of the endpoint devices 116a, . . . , 116f described with respect to FIG. 1A, FIG. 1B and/or FIG. 1C. The GNSS receiver 168 and GNSS antenna 136 may be similar or the substantially the same as the GNSS receiver 168 and GNSS antenna 136 described with respect to FIG. 1D.

The antenna 172 may be suitable for transmitting and/or receiving cellular, WiFi, WirelessHD and/or other types of wireless signals. Although a single antenna is illustrated, the invention is not so limited. In this regard, the cellular Tx/Rx 174a and/or one or more wireless Tx/Rx 176 interfaces may utilize a common antenna for transmission and reception, may utilize different antennas for transmission and reception and/or may utilize a plurality of antennas for transmission and/or reception.

The cellular Tx/Rx 174a may be similar to or the same as the cellular Tx/Rx 154 described with respect to FIG. 1D. The cellular Tx/Rx 174a may enable communication between an endpoint device 116 and one or more femtocells such as the femtocell 110. In various embodiments of the invention, the cellular Tx/Rx 174a may comprise a rake receiver that may combine signals received from a plurality of femtocells. In this regard, the rake receiver may combine signals that are received within a specified delay spread from one or more femtocells. In other embodiments of the invention, synchronized signal transmissions from a plurality of femtocells that are received by the cellular Tx/Rx 174a via the cellular antenna 172, may constructively combine such that a more robust signal is received. In this regard, the plurality of femtocells may be enabled to lower their transmission power levels. Although the FIG. 1F comprises two Tx/Rx units for cellular and WiFi, the endpoint devices 116 are not limited in this regard. For example, the endpoint devices 116 may be a multi-mode device that may comprise a plurality of Tx/Rx units and may be operable to communicate based on a plurality of wireless voice and/or data communication standards, for example, 3GPP, 3GPP2, LTE, WIMAX, 802.11, Bluetooth and Zigbee.

The WiFi Tx/Rx 176b may be similar and/or the same as the wireless Tx/Rx 126 described with respect to FIG. 1E. In this regard, the WiFi Tx/Rx 176b may comprise suitable logic, circuitry and/or code that may be operable transmit and/or receive signals to and/or from the AP 112c based on one or more 802.11 communication standards. In various embodiments of the invention, the WiFi Tx/Rx 176b may receive control signals from the femtocell 110 and/or send status information to the femtocell 110 for the endpoint device 116.

The WirelessHD Tx/Rx 176c may be similar and/or the same as the wireless Tx/Rx 126 described with respect to FIG. 1E. In this regard, the WirelessHD Tx/Rx 176c may comprise suitable logic, circuitry and/or code that may be operable transmit and/or receive signals to and/or from the AP 112b based on one or more WirelessHD communication standards. In various embodiments of the invention, the WirelessHD Tx/Rx 176d may receive control signals from the femtocell 110 and/or send status information to the femtocell 110 for the endpoint device 116.

The wired LAN Tx/Rx 176d may comprise suitable logic, circuitry and/or code to enable the endpoint device 116 to communicate with one or more of the APs 112 and/or the femtocell 110 based on the 802.3 communication standard and/or variations thereof. In various embodiments of the invention, the wired LAN Tx/Rx 176d may receive control signals from the femtocell 110 and/or send status information to the femtocell 110 for the endpoint device 116.

The processor 178 may comprise suitable logic, circuitry, and/or code that may enable processing of data and/or controlling operations of the endpoint devices 116. In this regard, the processor 178 may be enabled to provide control signals to the various other blocks within the endpoint devices 116. The processor 178 may also control data transfers between various portions of the endpoint device. Additionally, the processor 178 may enable execution of applications programs and/or code. In various embodiments of the invention, the applications, programs, and/or code may enable processing data. In various embodiments of the invention, the applications, programs, and/or code may enable, for example, configuring or controlling operation of the cellular Tx/Rx 174a, the WiFi Tx/Rx 174b, the WirelessHD Tx/Rx 174c, the wired LAN Tx/Rx 174d, the GNSS receiver 168, the DSP 182, and/or the memory 180. In various embodiments of the invention, the processor 178 may receive control information from the femtocell 110 and/or the network control processor 192. In this regard, the processor 178 may be enabled to provide one or more signals to the Tx/Rx 174a . . . 174d, the memory 180, and/or the DSP 182 to control communication between the endpoint device 116 and the femtocell 110 or the APs 112. In addition, the processor 178 may control parameters such as power level, modulation scheme, error coding scheme, and/or data rates of transmitted signals. In addition the processor 178 may handle content protection for example based on IPsec.

The memory 180 may comprise suitable logic, circuitry, and/or code that may enable storage or programming of information that comprises parameters and/or code that may effectuate the operation of the endpoint devices 116. A portion of the programming information and/or parameters may be received from the femtocell 110. Parameters may comprise configuration data and the code may comprise operational code such as software and/or firmware, but the information need not be limited in this regard. Moreover, the parameters may include adaptive filter and/or block coefficients. Additionally, the memory 180 may buffer or otherwise store received data and/or data to be transmitted. In various embodiments of the invention, the memory 180 may comprise one or more look-up tables which may be utilized for determining Femtocells and/or APs within a range of the endpoint devices 116.

The DSP 182 may comprise suitable logic, circuitry, and/or code operable to perform computationally intensive processing of data. In various exemplary embodiments of the invention, the DSP 182 may encode, decode, modulate, demodulate, encrypt, decrypt, scramble, descramble, and/or otherwise process data. In various exemplary embodiments of the invention, the DSP 182 may be enabled to adjust a modulation scheme, error coding scheme, and/or data rates of transmitted signal data.

In operation, the endpoint devices 116 may communicate with remote communication devices (not shown) via one or more of the femtocell 110 and the APs 112 that are controlled by the femtocell 110. The femtocell 110 may provide control information to the endpoint devices 116. In addition, the femtocell 110 may assign a particular femtocell 110 and/or AP 112 to handle a call and/or session of the endpoint device 116 as described with respect to FIG. 1A . . . FIG. 1F. The femtocell 110 may handle QoS, content protection and/or bandwidth allocation for data and/or voice traffic of an endpoint device 116.

In an exemplary embodiment of the invention, control messages from the femtocell 110 may be received by the endpoint devices 116 via the cellular Tx/Rx 174a, the WiFi Tx/Rx 174b and/or the wired LAN Tx/Rx 174d. The processor 178 may utilize the received control information to configure the endpoint devices 116 and/or to manage call and/or session set up and/or call and/or session processing. In addition, the endpoint devices 116 may receive control signals from the femtocell 110 for transmission power levels, error coding scheme, data rates, and modulation scheme.

Furthermore, the endpoint devices 116 may communicate various operational status and/or measurements to the femtocell 110. For example, the cellular Tx/Rx 174a, the WiFi Tx/Rx 174b, and/or the WirelessHD Tx/Rx 147c may determine signal characteristics such as interference levels and received signal strength. Similarly, the DSP 182 and/or the processor 178 may determine bit error rates of received data and available bandwidth of cellular, WiFi, WirelessHD and/or wired LAN channels. Information stored in the memory 160 and/or measurements taken by the Tx/Rx 174a . . . Tx/Rx 174d and/or the DSP 182 may be communicated to the femtocell.

In various embodiments of the invention, the endpoint devices 116 may be a multimode wireless device and may comprise a plurality of diverse wireless transmitters and/or receivers (Tx/Rx). In this regard, the endpoint devices 116 may be operable to receive signals from one or more femtocells or APs that may utilize different wireless standards. The endpoint devices 116 may be operable to select portions of information and/or combine information from the plurality of received signals based on the quality of received information and/or the quality of the received signals.

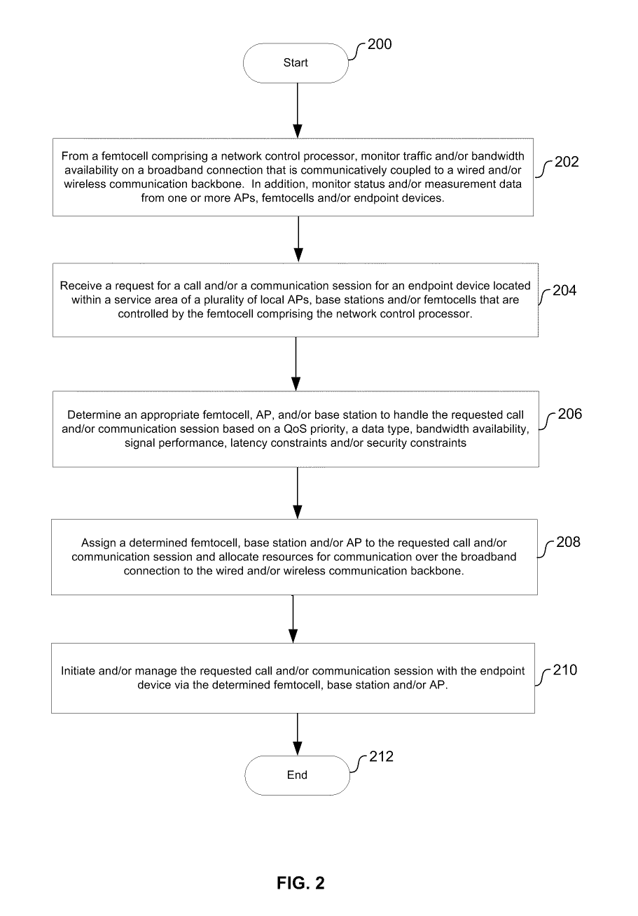

FIG. 2 illustrates exemplary steps for managing data delivery to one or more endpoint devices by a femtocell comprising a network control processor, in accordance with an embodiment of the invention. Referring to FIG. 2, the exemplary steps may begin with start step 200. In step 202, from a femtocell 110 comprising a network control processor 192, monitor traffic and/or bandwidth availability on a broadband connection 106 that is communicatively coupled to a wired and/or wireless communication backbone 102. In addition, monitor status and/or measurement data from one or more APs 112, femtocells 110 and/or endpoint devices 116. In step 204, the femtocell 110 may receive a request for a call and/or communication session for an endpoint device 116 located within a service area of a plurality of local APs 112, base stations 112d and/or femtocells 110 that are controlled by the femtocell 110 comprising the network control processor 192. In step 206, the femtocell 110 may determine an appropriate femtocell 110, AP 112, and/or base station 112d to handle the requested communication session and/or call based on QoS priority, data type of the call and/or session, bandwidth availability, signal performance, latency constraints and/or security constraints. In step 208, the femtocell 110 may assign a determined femtocell 110, base station 112d and/or AP 112 to the requested call and/or communication session and may allocate resources for communication over the broadband connection 106 to the wired and/or wireless communication backbone 102. In step 210, the femtocell 110 may initiate and/or manage the requested call and or communication session with the endpoint device 116 via the determined femtocell 110, base station 112d and/or AP 112. The step 212 may be an end of exemplary steps.

In various embodiments of the invention, a communication system 118 may comprise a femtocell 110, one or more other femtocells 112e one or more end-point devices 116, one or more base stations 112d and/or one or more access points 112. The femtocell 110 may comprise a network controller, for example, the network control processor 192, that may control communication of data between and/or among any two or more of the femtocell 110, the one or more other femtocells 112e, the one or more end-point devices 116, the one or more base stations 112d and/or the one or more access points 112. In addition, the network controller 192 within the femtocell 110 may control communication of the data between a communication device external to the communication system 118, for example, a device within a network 104, and one or more of the femtocell 110, the one or more other femtocells 112e, the one or more end-point devices 116, the one or more base stations 112d and/or the one or more access points 112. In this regard, the network controller 192 within the femtocell 110 may receive and/or analyze status, measurements and/or operating constraints of one or more of the femtocell 110, the one or more other femtocells 112e, the one or more end-point devices 116, the one or more base stations 112d and/or the one or more access points 112.

Furthermore, quality of service constraints, latency constraints, data type constraints and/or security constraints for the communication of the data may be determined. The network controller 192 within the femtocell 110 may allocate physical and/or logical resources, may control security and/or quality of service and/or may allocate bandwidth for the communication of the data. In various embodiments of the invention, the network controller 192 in the femtocell 110 may assign one or more of the femtocell 110, the one or more other femtocells 112e, the one or more end-point devices 116, the one or more base stations 112d and/or the one or more access points 112 to handle the communication of the data. In this regard, the data may be communicated via one or more of wired, optical and/or wireless interfaces.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for optimal control of data delivery paths for a femtocell network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a communication system comprising a femtocell, one or more other femtocells, one or more end-point devices, one or more base stations and/or one or more access points, controlling via a network controller within said femtocell, communication of data between and/or among any two or more of said femtocell, said one or more other femtocells, said one or more end-point devices, said one or more base stations and/or said one or more access points.

2. The method according to claim 1, comprising controlling via said network controller within said femtocell, communication of said data between a communication device external to said communication system and said one or more of said femtocell, said one or more other femtocells, said one or more end-point devices, said one or more base stations and/or said one or more access points.

3. The method according to claim 1, comprising, receiving and/or analyzing by said network controller within said femtocell, status, measurements and/or operating constraints of one or more of said femtocell, said one or more other femtocells, said one or more end-point devices, said one or more base stations and/or said one or more access points.

4. The method according to claim 1, comprising, determining quality of service constraints, latency constraints, data type and/or security constraints for said communication of said data.

5. The method according to claim 1, comprising allocating via said network controller within said femtocell, physical and/or logical resources for said communication of said data.

6. The method according to claim 1, comprising controlling via said network controller within said femtocell, quality of service for said communication of said data.

7. The method according to claim 1, comprising allocating via said network controller within said femtocell, bandwidth for said communication of said data.

8. The method according to claim 1, comprising controlling via said network controller within said femtocell security for said communication of said data.

9. The method according to claim 1, comprising assigning via said network controller within said femtocell one or more of said femtocell, said one or more other femtocells, said one or more end-point devices, said one or more base stations and/or said one or more access points to handle said communication of said data.

10. The method according to claim 1, comprising communicating said data via one or more of wired, optical and/or wireless interfaces.

11. In a communication system comprising a femtocell, one or more other femtocells, one or more end-point devices, one or more base stations and/or one or more access points, a system for communication, the system comprising:
one or more circuits for use in a network controller within said femtocell, wherein said one or more circuits are operable to control communication of data between and/or among any two or more of said femtocell, said one or more other femtocells, said one or more end-point devices, said one or more base stations and/or said one or more access points.

12. The system according to claim 11, wherein said one or more circuits are operable to control communication of said data between a communication device external to said communication system and said one or more of said femtocell, said one or more other femtocells, said one or more end-point devices, said one or more base stations and/or said one or more access points.

13. The system according to claim 11, wherein said one or more circuits are operable to receive and/or analyze status, measurements and/or operating constraints of one or more of said femtocell, said one or more other femtocells, said one or more end-point devices, said one or more base stations and/or said one or more access points.

14. The system according to claim 11, wherein said one or more circuits are operable to determine quality of service constraints, latency constraints, data type constraints and/or security constraints for said communication of said data.

15. The system according to claim 11, wherein said one or more circuits are operable to allocate physical and/or logical resources for said communication of said data.

16. The system according to claim 11, wherein said one or more circuits are operable to control quality of service for said communication of said data.

17. The system according to claim 11, wherein said one or more circuits are operable to allocate via bandwidth for said communication of said data.

18. The system according to claim 11, wherein said one or more circuits are operable to control security for said communication of said data.

19. The system according to claim 11, wherein said one or more circuits are operable to assign one or more of said femtocell, said one or more other femtocells, said one or more end-point devices, said one or more base stations and/or said one or more access points to handle said communication of said data.

20. The system according to claim 11, wherein said one or more circuits are operable to communicate said data via one or more of wired, optical and/or wireless interfaces.
